(19) United States
(12) Patent Application Publication
(10) Pub. No.: US 2018/0316896 A1
(43) Pub. Date: Nov. 1, 2018

(54) SURVEILLANCE CAMERA, INFORMATION PROCESSING DEVICE, INFORMATION PROCESSING METHOD, AND RECORDING MEDIUM

(71) Applicant: CANON KABUSHIKI KAISHA, Tokyo (JP)

(72) Inventor: Shintaro Higuchi, Kawasaki-shi (JP)

(21) Appl. No.: 15/953,294

(22) Filed: Apr. 13, 2018

(30) Foreign Application Priority Data
Apr. 26, 2017 (JP) 2017-087594

(51) Int. Cl. H04N 7/18; G08B 13/196; G10L 25/51

(52) U.S. Cl. CPC H04N 7/188; G10L 25/51; G08B 13/19695

(57) ABSTRACT

A surveillance camera outputs data if audio data of sound collected by a sound collector contains a specified sound component. The surveillance camera terminates outputting of the data when the sound volume of the audio data of the output data reaches or falls below a predetermined sound volume.

### BACKGROUND

### Field

The present disclosure relates to a surveillance camera, an information processing device, an information processing method, and a recording medium.

### Description of the Related Art

In recent years, network cameras have been used for street security and for monitoring the interiors of stores, buildings, and factories. Many network cameras also include a capability to record and deliver ambient sound using an external microphone or using a built-in microphone, in addition to a capability to capture a video image. This functionality enables the surveillant to monitor not only a video image, but also sound in the monitored area, and can thus improve the surveillance performance. Sound data can contain information of more personal nature than information contained in a video image, and thus, recording and delivering sound data with little or no limitation can cause concern in view of protection of privacy.

An example audio function of a network camera is sound volume detection. Sound volume detection enables the network camera to monitor the volume of sound using a microphone, and to detect occurrence of an event when the sound volume reaches or exceeds a certain level, or otherwise reaches or falls below a certain level. Such a network camera can operate, for example, to begin delivering video data and sound data upon occurrence of an event of sound volume detection. Delivering video data and sound data only upon occurrence of an event of sound volume detection enables the video data and the sound data to be delivered only when needed, thereby enabling protection of privacy and improvement in the surveillance performance to be both provided.

A network camera can include a function of detecting a specific sound component in the sound. A function of detecting a specific sound component provides an advantage in reducing false detection of non-abnormal sound even when that non-abnormal sound has sound volume at or above a certain level, and in detecting abnormal sound when that abnormal sound has relatively low sound volume, neither of which can be provided by sound volume detection.

One example of technology related to a function of detecting a specific sound component in the sound is a technology described in Japanese Patent Laid-Open No. 2007-295484.

The technology described in Japanese Patent Laid-Open No. 2007-295484 is likely to terminate the process of outputting moving image data before elapse of the time period expected for outputting the moving image data, thereby to fail to deliver and/or record moving image data containing sufficient information to perform successful surveillance.

### SUMMARY

According to an aspect of the present disclosure, surveillance camera includes an image pickup unit configured to capture an image, a sound collector associated with the image pickup unit, the sound collector configured to collect sound, and a control unit configured to output moving image data based on audio data of the collected sound containing a specific sound component, wherein the control unit terminates outputting of the moving image data when sound volume of the collected sound reaches or falls below a predetermined sound volume.

Further features will become apparent from the following description of exemplary embodiments with reference to the attached drawings.

### BRIEF DESCRIPTION OF THE DRAWINGS

FIG. 1 is a diagram illustrating one example of hardware configuration of an imaging apparatus according to one embodiment of the present disclosure.

FIG. 2 is a flowchart illustrating one example of information processing associated with delivery of sound data and the like according to one embodiment of the present disclosure.

FIG. 3 is a flowchart illustrating another example of information processing associated with delivery of sound data and the like according to one embodiment of the present disclosure.

FIGS. 4A and 4B are each a diagram illustrating one example of components of an imaging apparatus according to one embodiment of the present disclosure.

### DESCRIPTION OF THE EMBODIMENTS

Exemplary embodiments of the present disclosure will be described below with reference to the drawings.

### First Embodiment

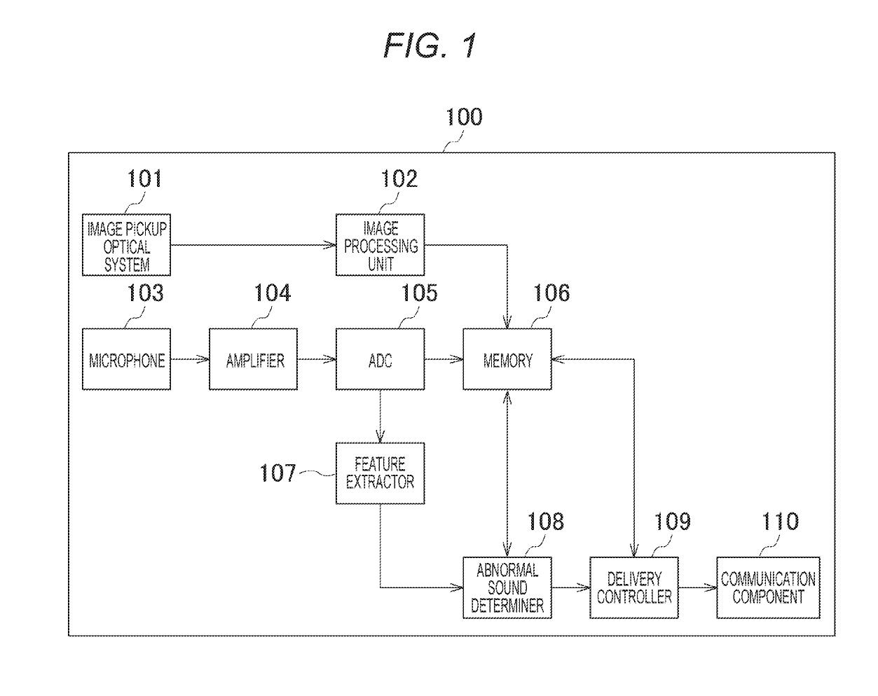

FIG. 1 is a diagram illustrating one example of hardware configuration of an imaging apparatus 100 according to a first embodiment.

The imaging apparatus 100 includes an image pickup optical system 101, an image processing unit 102, a microphone 103, an amplifier 104, an analog-to-digital converter (ADC) 105, a memory 106, a feature extractor 107, an abnormal sound determiner 108, a delivery controller 109, and a communication component 110. The image pickup optical system 101 includes multiple lenses, an iris, an optical filter such as an infrared cut filter, a photoelectric conversion device, such as a charge coupled device (CCD) or a complementary metal oxide semiconductor (CMOS) device. The image pickup optical system 101 is one example of image pickup unit.

The image processing unit 102 performs image processing (e.g., color balance adjustment and/or gamma correction) in a predetermined manner based on a signal from the image pickup optical system 101, and then generates an image file in a predetermined format such as JPEG format. An image file in a predetermined format is one example of image data.

The microphone 103 is a sound collection device included in the imaging apparatus 100. The microphone 103 collects sound around the imaging apparatus 100, and outputs an audio signal representing the collected sound to the amplifier 104. The microphone 103 is one example of sound collector.

The amplifier 104 amplifies the audio signal input from the microphone 103 for processing performed in the ADC 105 provided downstream of the amplifier 104.

The ADC 105 digitally samples the analog signal from the amplifier 104 to generate digital audio data (hereinafter referred to as “audio data”). The audio data is one example of audio data of the sound collected by the microphone 103, which is one example of sound collector.

The memory 106 temporarily stores the image file and the audio data to synchronize, and associate, the image file output from the image processing unit 102 with the audio data output from the ADC 105. The memory 106 also temporarily stores information on the sound volume of the sound represented by the audio data (hereinafter referred to simply as “the sound volume of the audio data”) output from the ADC 105. The memory 106 also stores feature parameter data about abnormal sound. The memory 106 can include therein a portable memory, such as a memory card, to store either one or both of the image file and the audio data.

The feature extractor 107 derives, for example, mel-frequency cepstrum coefficients (MFCCs) from the audio data output from the ADC 105, derives a feature set having values thereof weighted in consideration of perception characteristics, and outputs the feature set derived.

The abnormal sound determiner 108 calculates a likelihood of the feature set output from the feature extractor 107 and a likelihood of a feature set for abnormal sound stored in the memory 106, and determines whether abnormal sound is contained based on the feature set output from the feature extractor 107. The abnormal sound determiner 108 then sends a notification of the determination result to the delivery controller 109.

The delivery controller 109 outputs the image file temporarily stored in the memory 106 to the communication component 110. The delivery controller 109 receives a notification whether abnormal sound is contained from the abnormal sound determiner 108, and the delivery controller 109 also outputs the audio data temporarily stored in the memory 106 to the communication component 110 in a case that the abnormal sound is contained in the audio data. The delivery controller 109 monitors the information on the sound volume of the sound represented by the audio data stored in the memory 106 to determine whether to output the image file and/or the audio data to the communication component 110. In a case in which the memory 106 includes therein a portable memory, the delivery controller 109 can copy the image file and/or the audio data temporarily stored in the memory 106 into the portable memory upon receipt of the notification whether abnormal sound is contained from the abnormal sound determiner 108.

The communication component 110 delivers the image file and the audio data based on the applicable network transmission protocol, such as, for example, TCP/IP or UDP.

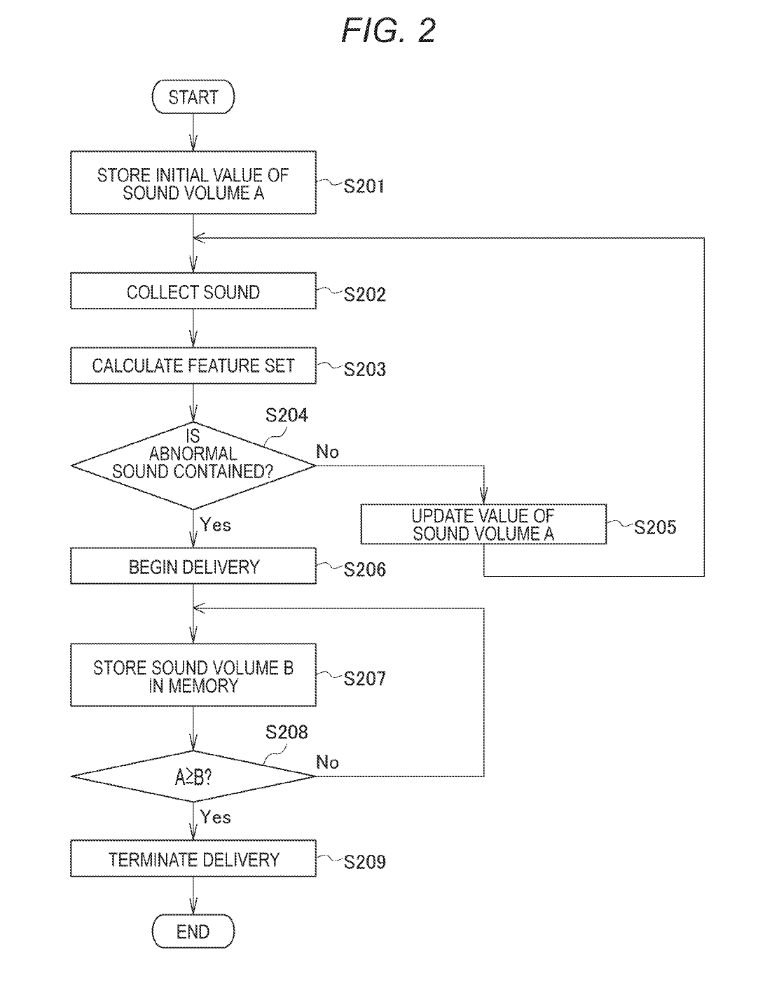

FIG. 2 is a flowchart illustrating one example of information processing associated with delivery of sound data and the like performed by the imaging apparatus 100 according to the first embodiment.

After power-on of the imaging apparatus 100, at step S201, the microphone 103 collects sound around the imaging apparatus 100. The amplifier 104 amplifies the audio signal representing the collected sound. The ADC 105 generates audio data from the output of the amplifier 104. The memory 106 stores the value of the sound volume of the audio data generated by the ADC 105, as the initial value of a parameter A, which is a parameter representing the sound volume. When a particular time period has elapsed, the process proceeds to step S202.

At step S202, the microphone 103 collects sound around the imaging apparatus 100. The amplifier 104 amplifies the audio signal representing the collected sound. The ADC 105 generates audio data from the output of the amplifier 104. The ADC 105 temporarily stores the value of the sound volume of the audio data generated, in the memory 106.

At step S203, the feature extractor 107 derives a feature set for the audio data generated at step S202.

At step S204, the abnormal sound determiner 108 calculates a likelihood of the feature set generated at step S203 and output from the feature extractor 107, and a likelihood of a feature set for abnormal sound stored in the memory 106, and determines whether abnormal sound is contained. If the abnormal sound determiner 108 determines that abnormal sound is not contained (No at step S204), the process proceeds to step S205.

At step S205, the abnormal sound determiner 108 updates the value of the sound volume parameter A with the value of the sound volume of the audio data stored, at step S202, in the memory 106.

If the abnormal sound determiner 108 determines that abnormal sound is contained (Yes at step S204), the abnormal sound determiner 108 sends a notification indicating that abnormal sound is contained in the sound to the delivery controller 109, and the process proceeds to step S206.

At step S206, upon receipt, from the abnormal sound determiner 108, of the notification indicating that abnormal sound is contained in the sound, the delivery controller 109 reads the image file and the audio data stored in the memory 106, and transmits the image file and the audio data to the communication component 110. In a case in which the delivery controller 109 previously transmitted the image file to the communication component 110, the delivery controller 109 can begin transmitting the audio data to the communication component 110. In addition, in a case in which the memory 106 includes therein a portable memory, instead of transmitting the image file and the audio data to the communication component 110, the delivery controller 109 can store the image file and the audio data in the portable memory. In this case, and in a case in which the delivery controller 109 previously stored the image file in the portable memory, the delivery controller 109 can begin storing the audio data in the portable memory. The delivery controller 109 can output either one or both of the image file and the audio data. Either one or both of the image file and the audio data is one example of output data. Note that, for simplicity of explanation, the description of the present embodiment hereafter is provided on the assumption that both the image file and the audio data are output unless otherwise indicated.

At step S207, the delivery controller 109 stores, in the memory 106, the value of the sound volume of the audio data being transmitted, as the value of a sound volume parameter B. The delivery controller 109 can update the sound volume parameter B stored in the memory 106 in real-time or with a regular period (e.g., one second). Even in a case in which only an image file is output, audio data corresponding to the image file output has been stored in the memory 106, and thus, the delivery controller 109 uses the audio data corresponding to the image file being output to update the value of the sound volume parameter B.

At step S208, the delivery controller 109 compares the value of the sound volume parameter A with the value of the sound volume parameter B stored in the memory 106. If the comparison indicates that the value of the parameter B is greater than the value of the parameter A (No at step S208), that is, if the sound volume after the beginning of the sound delivery is higher than the sound volume before the beginning of the sound delivery, the delivery controller 109 continues the delivery, and the process returns to step S207. If the comparison indicates that the value of the parameter B is less than or equal to the value of the parameter A (Yes at step S208), that is, if the sound volume after the beginning of the sound delivery is less than or equal to the sound volume before the beginning of the sound delivery, the process proceeds to step S209. The sound volume before the beginning of the sound delivery is one example of predetermined sound volume.

At step S209, the delivery controller 109 terminates the process of delivering the applicable data to the communication component 110. The delivery controller 109 can terminate only the process of delivering the audio data. In a case in which the memory 106 includes therein a portable memory, and the delivery controller 109 is performing the process of storing applicable data in the portable memory, the delivery controller 109 can terminate the process of storing the audio data, or both the image file and the audio data, into the portable memory.

According to the present embodiment, the imaging apparatus 100 can detect a specific sound component in the sound, beginning outputting either one or both of video image data and audio data, and terminating the delivery process at an appropriate time. In other words, beginning and terminating the outputting process at an appropriate time depending on characteristics of the sound enables protection of privacy and improvement in the surveillance performance to be both provided.

### Second Embodiment

The hardware configuration of the imaging apparatus 100 according to a second embodiment is similar to the hardware configuration of the imaging apparatus 100 according to the first embodiment.

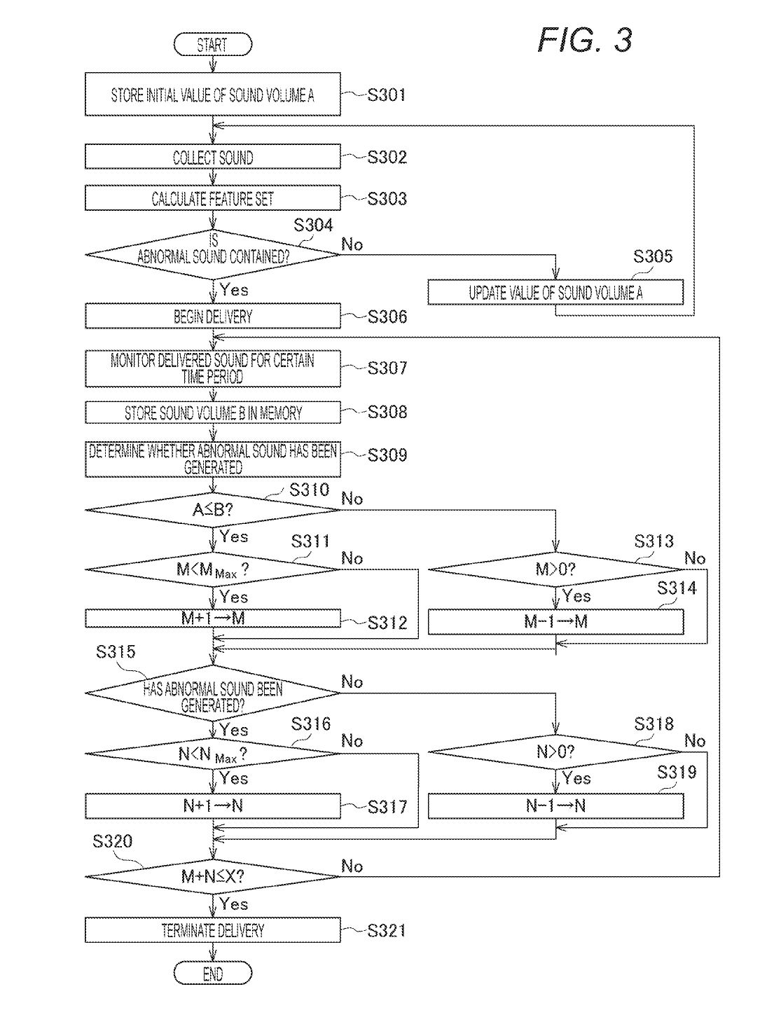

FIG. 3 is a flowchart illustrating one example of information processing associated with delivery of sound data and the like performed by the imaging apparatus 100 according to the second embodiment.

After power-on of the imaging apparatus 100, at step S301, the microphone 103 collects sound around the imaging apparatus 100. The amplifier 104 amplifies the audio signal representing the sound collected. The ADC 105 generates audio data from the output of the amplifier 104. The memory 106 stores the value of the sound volume of the audio data generated by the ADC 105, as the initial value of the parameter A, which is a parameter representing the sound volume. When a particular time period has elapsed, the process proceeds to step S302.

At step S302, the microphone 103 collects sound around the imaging apparatus 100. The amplifier 104 amplifies the audio signal representing the sound collected. The ADC 105 generates audio data from the output of the amplifier 104. The ADC 105 temporarily stores the value of the sound volume of the generated audio data in the memory 106.

At step S303, the feature extractor 107 derives a feature set for the audio data generated at step S302.

At step S304, the abnormal sound determiner 108 calculates a likelihood of the feature set generated at step S303 and output from the feature extractor 107, and a likelihood of a feature set for abnormal sound stored in the memory 106, and determines whether abnormal sound is contained. If the abnormal sound determiner 108 determines that abnormal sound is not contained (No at step S304), the process proceeds to step S305.

At step S305, the abnormal sound determiner 108 updates the value of the sound volume parameter A with the value of the sound volume of the audio data stored at step S302 in the memory 106.

If the abnormal sound determiner 108 determines that abnormal sound is contained (Yes at step S304), the abnormal sound determiner 108 sends a notification indicating that abnormal sound is contained in the sound to the delivery controller 109 and the process proceeds to step S306.

At step S306, upon receipt from the abnormal sound determiner 108 of the notification indicating that abnormal sound is contained in the sound, the delivery controller 109 reads the image file and the audio data stored in the memory 106, and transmits the image file and the audio data to the communication component 110. In a case in which the delivery controller 109 previously transmitted the image file to the communication component 110, the delivery controller 109 can begin transmitting the audio data to the communication component 110. In addition, in a case in which the memory 106 includes therein a portable memory, instead of transmitting the image file and the audio data to the communication component 110, the delivery controller 109 can store the image file and the audio data in the portable memory. In this case, and in a case in which the delivery controller 109 previously stored the image file in the portable memory, the delivery controller 109 can begin storing the audio data in the portable memory. The delivery controller 109 can output either one or both of the image file and the audio data. Either one or both of the image file and the audio data is one example of output data. Note that, for simplicity of explanation, the description of the present embodiment hereafter is provided on the assumption that both the image file and the audio data are output unless otherwise indicated.

At step S307, the delivery controller 109 monitors the audio data being delivered for a certain time period. One monitoring period is, for example, 30 seconds. In a case in which only an image file is output, the audio data corresponding to the image file output has been stored in the memory 106, and thus, the delivery controller 109 monitors the audio data corresponding to the image file being output for a certain time period.

At step S308, the delivery controller 109 temporarily stores, in the memory 106, the value of the highest sound volume in the audio data generated by the ADC 105 during the monitoring period, as the value of the sound volume parameter B.

At step S309, the feature extractor 107 derives a feature set for the audio data generated by the ADC 105 during the monitoring period. The abnormal sound determiner 108 calculates a likelihood of the feature set output from the feature extractor 107 and a likelihood of a feature set for abnormal sound stored in the memory 106. The process at step S309 is one example of a process of detecting the specified sound component from the audio data of the output data.

At step S310, the delivery controller 109 compares the value of the sound volume parameter A with the value of the sound volume parameter B stored in the memory 106. If the determination at step S310 indicates that the value of the sound volume parameter B is greater than or equal to the value of the sound volume parameter A (Yes at step S310), the process proceeds to step S311.

At step S311, the delivery controller 109 compares the value of a parameter M associated with a general characteristic of the sound volume of the audio data being delivered (hereinafter referred to simply as “sound volume of the ongoing delivery”), and the value of a constant Mmax associated with the general characteristic of the sound volume of the ongoing delivery. The initial value of the parameter M associated with the general characteristic of the sound volume of the ongoing delivery is, for example, 3. The value of the constant Mmax associated with the general characteristic of the sound volume of the ongoing delivery is, for example, 5. The value of the parameter M associated with the general characteristic of the sound volume of the ongoing delivery and the value of the constant Mmax associated with the general characteristic of the sound volume of the ongoing delivery are stored in the memory 106. If the determination at step S311 indicates that the value of the parameter M associated with the general characteristic of the sound volume of the ongoing delivery is less than the value of the constant Mmax associated with the general characteristic of the sound volume of the ongoing delivery (Yes at step S311), the process proceeds to step S312.

At step S312, the delivery controller 109 increments, by 1, the value of the parameter M associated with the general characteristic of the sound volume of the ongoing delivery. If the determination at step S311 indicates that the value of the parameter M associated with the general characteristic of the sound volume of the ongoing delivery is greater than or equal to the value of the constant Mmax associated with the general characteristic of the sound volume of the ongoing delivery (No at step S311), the process proceeds to step S315.

If the determination at step S310 indicates that the value of the sound volume parameter B is less than the value of the sound volume parameter A (No at step S310), the process proceeds to step S313.

At step S313, the delivery controller 109 compares the value of the parameter M associated with the general characteristic of the sound volume of the ongoing delivery with “0.”

If the determination at step S313 indicates that the value of the parameter M associated with the general characteristic of the sound volume of the ongoing delivery is greater than “0” (Yes at step S313), the process proceeds to step S314.

At step S314, the delivery controller 109 decrements, by 1, the value of the parameter M associated with the general characteristic of the sound volume of the ongoing delivery. If the determination at step S313 indicates that the value of the parameter M associated with the general characteristic of the sound volume of the ongoing delivery is “0” (No at step S313), the process proceeds to step S315.

At step S315, the delivery controller 109 receives information whether abnormal sound has been generated during the period of monitoring performed by the abnormal sound determiner 108. If the determination at step S315 indicates that abnormal sound has been generated (Yes at step S315), the process proceeds to step S316.

At step S316, the delivery controller 109 compares the value of a parameter N, which is associated with a general characteristic of the abnormal sound in the ongoing delivery, with the value of a constant Nmax, which is associated with the general characteristic of the abnormal sound in the ongoing delivery. The initial value of the parameter N associated with the general characteristic of the abnormal sound is, for example, 3. The value of the constant Nmax associated with the general characteristic of the abnormal sound in the ongoing delivery is, for example, 5. The value of the parameter N associated with the abnormal sound and the value of the constant Nmax associated with the general characteristic of the abnormal sound in the ongoing delivery are stored in the memory 106.

If the determination at step S316 indicates that the value of the parameter N associated with the general characteristic of the abnormal sound is less than the value of the constant Nmax associated with the general characteristic of the abnormal sound in the ongoing delivery (Yes at step S316), the process proceeds to step S317.

At step S317, the delivery controller 109 increments, by 1, the value of the parameter N associated with the general characteristic of the abnormal sound in the ongoing delivery. If the determination at step S316 indicates that the value of the parameter N associated with the general characteristic of the abnormal sound in the ongoing delivery is greater than or equal to the value of the constant Nmax associated with the general characteristic of the abnormal sound in the ongoing delivery (No at step S316), the process proceeds to step S320.

If the determination at step S315 indicates that abnormal sound has not been generated (No at step S315), the process proceeds to step S318.

At step S318, the delivery controller 109 compares the value of the parameter N associated with the general characteristic of the abnormal sound in the ongoing delivery with “0.”

If the determination at step S318 indicates that the value of the parameter N associated with the general characteristic of the abnormal sound in the ongoing delivery is greater than “0” (Yes at step S318), the process proceeds to step S319.

At step S319, the delivery controller 109 decrements, by 1, the value of the parameter N associated with the general characteristic of the abnormal sound in the ongoing delivery. If the determination at step S318 indicates that the value of the parameter N associated with the general characteristic of the abnormal sound in the ongoing delivery is “0” (No at step S318), the process proceeds to step S320.

At step S320, the delivery controller 109 compares the sum of the value of the parameter M associated with the general characteristic of the sound volume of the ongoing delivery and the value of the parameter N associated with the general characteristic of the abnormal sound, with the value of a constant X for determining whether to continue the delivery. The value of the constant X is, for example, 3. The value of the constant X is stored in the memory 106.

If the determination at step S320 indicates that the sum of the value of the parameter M associated with the general characteristic of the sound volume of the ongoing delivery and the value of the parameter N associated with the general characteristic of the abnormal sound is less than or equal to the value of the constant X for determining whether to continue the delivery (Yes at step S320), the process proceeds to step S321.

At step S321, the delivery controller 109 terminates the process of transmitting the applicable data to the communication component 110. The delivery controller 109 can terminate only the process of delivering the audio data. In a case in which the memory 106 includes therein a portable memory, and the delivery controller 109 is performing the process of storing the audio data or both the image file and the audio data into the portable memory, the delivery controller 109 can terminate the process of storing the audio data or both the image file and the audio data into the portable memory.

If the determination at step S320 indicates that the sum of the value of the parameter M associated with the general characteristic of the sound volume of the ongoing delivery and the value of the parameter N associated with the general characteristic of the abnormal sound is greater than the value of the constant X for determining whether to continue the delivery (No at step S320), the delivery controller 109 instructs the communication component 110 to continue to transmit the applicable data. The process then returns to step S307.

According to the present embodiment, the imaging apparatus 100 can detect a specific sound component in the sound, and begin outputting either one or both of video image data and audio data. If the specific sound component has not been generated for a certain time period, and the sound volume has been lower than a predetermined value for a certain time period, the imaging apparatus 100 can terminate the outputting process. Thus, protection of privacy and improvement in the surveillance performance can both be provided.

### Third Embodiment

The foregoing embodiments have been described in terms of examples of the imaging apparatus 100 including the feature extractor 107 and other similar components as hardware components. However, the feature extractor 107 and other similar components can be implemented as software components in the imaging apparatus 100.

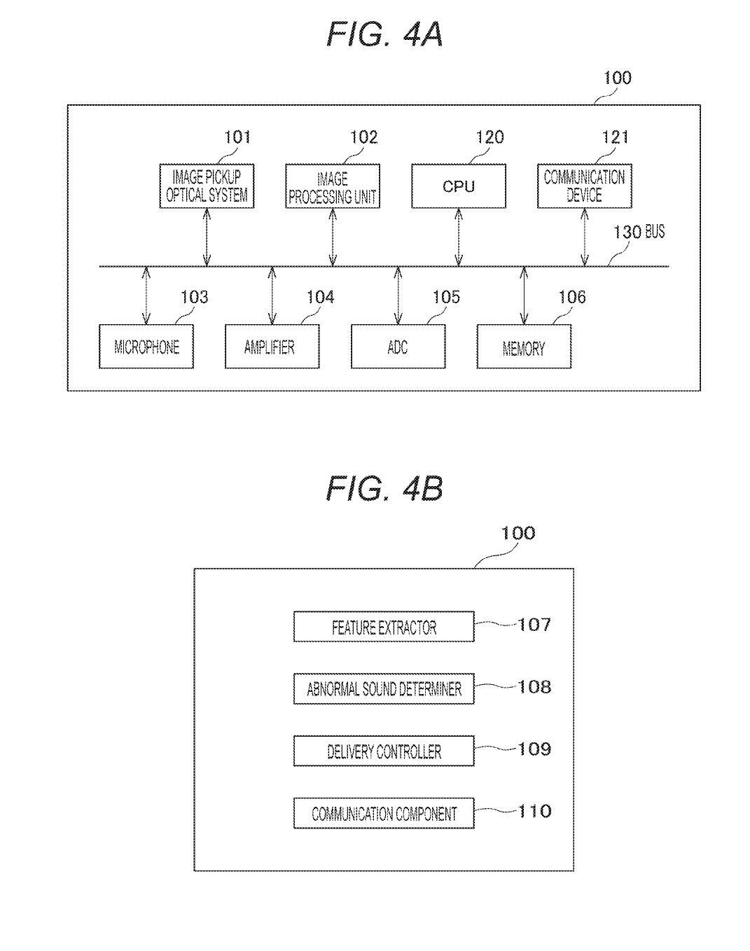

FIG. 4A is a diagram illustrating one example of a set of hardware components of the imaging apparatus 100 according to a third embodiment. As illustrated in FIG. 4A, the imaging apparatus 100 includes, as hardware components, the image pickup optical system 101, the image processing unit 102, the microphone 103, the amplifier 104, the ADC 105, the memory 106, a central processing unit (CPU) 120, and a communication device 121. These hardware components are communicatively connected to one another via a bus 130. In the present embodiment, the hardware components previously described in the foregoing embodiments will not be further described unless otherwise necessary. The CPU 120 controls the entirety of the imaging apparatus 100. The memory 106 stores the image file, the audio data, etc., as well as programs. The communication device 121 is a device that connects the imaging apparatus 100 to a network and/or to an external device. The imaging apparatus 100 is connected to a network and/or to an external device via the communication device 121 wirelessly or via a wired connection. The CPU 120 performs a process according to a program stored in the memory 106 to implement the software configuration of the imaging apparatus 100 illustrated in FIG. 4B. In addition, the CPU 120 performs a process according to a program stored in the memory 106 to provide all or a part of the processes described above and illustrated in the flowcharts of FIGS. 2 and 3.

FIG. 4B is a diagram illustrating one example of a set of software components of the imaging apparatus 100 according to the third embodiment. As illustrated in FIG. 4B, the imaging apparatus 100 includes, as software components, the feature extractor 107, the abnormal sound determiner 108, the delivery controller 109, and the communication component 110.

The feature extractor 107 derives, for example, mel-frequency cepstrum coefficients (MFCCs) from the audio data output from the ADC 105, derives a feature set with values thereof weighted in consideration of perception characteristics, and outputs the derived feature set.

The abnormal sound determiner 108 calculates a likelihood of the feature set output from the feature extractor 107 and a likelihood of a feature set for abnormal sound stored in the memory 106, and determines whether abnormal sound is contained based on the feature set output from the feature extractor 107. The abnormal sound determiner 108 then sends a notification of the determination result to the delivery controller 109.

The delivery controller 109 outputs the image file temporarily stored in the memory 106 to the communication component 110. The delivery controller 109 receives a notification whether abnormal sound is contained from the abnormal sound determiner 108, and the delivery controller 109 also outputs the audio data temporarily stored in the memory 106 to the communication component 110 in a case that the abnormal sound is contained in the audio data. The delivery controller 109 monitors the information on the sound volume of the sound represented by the audio data stored in the memory 106 to determine whether to output the image file and the audio data to the communication component 110. In a case in which the memory 106 includes therein a portable memory, the delivery controller 109 can copy the image file and the audio data temporarily stored in the memory 106 into the portable memory upon receipt of the notification of whether abnormal sound is contained from the abnormal sound determiner 108.

The communication component 110 delivers the image file and the audio data through the communication device 121 based on the applicable network transmission protocol such as, for example, TCP/IP or UDP.

The imaging apparatus 100 according to the present embodiment can also provide similar advantages to those provided by the imaging apparatus 100 according to each of the foregoing embodiments.

### Other Embodiments

At least one function of the above-described embodiments can also be implemented by at least one program being supplied to a system or to a device via a network or a storage medium and at least one processor of a computer installed in the system or in the device reading and executing the at least one program. The at least one function can also be implemented in a circuit (e.g., application-specific integrated circuit (ASIC)) that provides at least one function of the described embodiments.

Exemplary embodiments of the present disclosure have been described in detail. However, these specific embodiments are not seen to be limiting.

For example, a graphics processing unit (GPU) can be used in place of the CPU 120 of FIG. 4A. In addition, while FIG. 4A illustrates the image processing unit 102 as a hardware component, the imaging apparatus 100 can include the image processing unit 102 as a software component.

While the foregoing embodiments have been described using the imaging apparatus 100 as an example, an information processing device connected with at least one imaging apparatus 100 can perform the information processing described above. In other words, such an information processing device can include the software components of the third embodiment, and can control beginning and terminating the outputting of either one or both of an image file associated with an image captured by at least one imaging apparatus 100 connected to the information processing device, and audio data associated with sound collected. In this case, the information processing device includes at least a CPU, a communication device, and a memory as hardware components, and enables the CPU to perform the processing according to a program stored in the memory thus to implement the software configuration and the like.

The processing according to each of the foregoing embodiments can provide both protection of privacy and improvement in the surveillance performance.

The present disclosure enables protection of privacy and improvement in the surveillance performance to be both provided.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-087594, filed Apr. 26, 2017, which is hereby incorporated by reference herein in its entirety.

What is claimed is:

1. A surveillance camera comprising:
an image pickup unit configured to capture an image;
a sound collector associated with the image pickup unit, the sound collector configured to collect sound; and
a control unit configured to output moving image data based on audio data of the collected sound containing a specific sound component,
wherein the control unit terminates outputting of the moving image data when sound volume of the collected sound reaches or falls below a predetermined sound volume.

2. The surveillance camera according to claim 1, wherein the control unit terminates outputting of the moving image data when the specific sound component has not been detected from audio data associated with the moving image data for a specific time period, and the sound volume of the audio data has been lower than the predetermined sound volume for a specific time period.

3. The surveillance camera according to claim 1, wherein the predetermined sound volume is sound volume of audio data before outputting of the moving image data begins.

4. The surveillance camera according to claim 1, wherein outputting of the moving image data is delivery of the moving image data to an external device.

5. The surveillance camera according to claim 1, wherein outputting of the moving image data is storing the moving image data in a portable memory.

6. The surveillance camera according to claim 1, wherein the moving image data is either one or both of the audio data of the collected sound and image data of the captured image.

7. An information processing device comprising:
a first acquisition unit configured to acquire moving image data from an image pickup unit;
a second acquisition unit configured to acquire audio data of sound collected by a sound collector associated with the image pickup unit; and
a control unit configured to output the moving image data based on the audio data containing a specific sound component,
wherein the control unit terminates outputting the moving image data when sound volume of the collected sound reaches or falls below a predetermined sound volume.

8. A method performed by a surveillance camera, the method comprising:
capturing an image;
collecting sound in a target area where the image was captured;
outputting moving image data based on audio data of the collected sound containing a specific sound component; and
terminating outputting the moving image data when sound volume of the collected sound reaches or falls below a predetermined sound volume.

9. The method according to claim 8, wherein outputting of the moving image data is terminated when the specific sound component has not been detected from audio data associated with the moving image data for a specific time period, and the sound volume of the audio data has been lower than the predetermined sound volume for a specific time period.

10. The method according to claim 8, wherein the predetermined sound volume is sound volume of audio data before outputting of the moving image data begins.

11. The method according to claim 8, wherein outputting of the moving image data is delivery of the moving image data to an external device.

12. The method according to claim 8, wherein outputting of the moving image data is storing the moving image data in a portable memory.

13. The method according to claim 8, wherein the moving image data is either one or both of the audio data of the collected sound and image data of the captured image.

14. A method performed by an information processing device comprising:
acquiring moving image data from an image pickup unit;
acquiring audio data of sound collected by a sound collector associated with the image pickup unit; and
outputting the moving image data based on the audio data containing a specific sound component,
wherein outputting of the moving image data is terminated when sound volume of the collected sound reaches or falls below a predetermined sound volume.

15. A non-transitory computer readable storage medium storing a program that causes a computer to execute a method, the method comprising:
capturing an image;
collecting sound in a target area where the image was captured;
outputting moving image data based on audio data of the collected sound containing a specific sound component; and
terminating outputting the moving image data when sound volume of the collected sound reaches or falls below a predetermined sound volume.

16. A non-transitory computer readable storage medium storing a program that causes a computer to execute a method, the method comprising:
acquiring moving image data from an image pickup unit;
acquiring audio data of sound collected by a sound collector associated with the image pickup unit; and
outputting the moving image data based on the audio data containing a specific sound component,
wherein outputting of the moving image data is terminated when sound volume of the collected sound reaches or falls below a predetermined sound volume.
